(19) United States
(12) Patent Application Publication
(10) Pub. No.: US 2025/0226148 A1
(43) Pub. Date: Jul. 10, 2025

(54) INTEGRATED TRANSFORMER AND POWER MODULE

(71) Applicant: Delta Electronics (Shanghai) CO., LTD., Shanghai (CN)

(72) Inventors: Quanliang ZHANG, Shanghai (CN); Wei WANG, Shanghai (CN); Rui LI, Shanghai (CN); Tiandong SHA, Shanghai (CN)

(73) Assignee: Delta Electronics (Shanghai) CO., LTD., Shanghai (CN)

(21) Appl. No.: 18/984,159

(22) Filed: Dec. 17, 2024

(30) Foreign Application Priority Data
Jan. 4, 2024 (CN) 2024100155504

(51) Int. Cl. H01F 27/32; H01F 3/14; H01F 27/245; H01F 30/06

(52) U.S. Cl. CPC H01F 27/323; H01F 3/14; H01F 27/245; H01F 30/06

(57) ABSTRACT

An integrated transformer includes: two magnetic cores, wherein each magnetic core includes two magnetic yokes arranged opposite to each other along a first direction and two magnetic columns located between the two magnetic yokes, the two magnetic columns are arranged opposite to each other along a second direction; two short-circuited magnetic blocks, wherein one magnetic yoke in one of the magnetic cores is connected to one magnetic yoke in the other magnetic core through one of the short-circuited magnetic blocks to connect the two magnetic cores in series into a ring; four first windings, wound on four magnetic columns of the two magnetic cores, respectively; and a second winding, wound on the magnetic core or the short-circuited magnetic block, wherein magnetic flux directions generated by the second winding in two magnetic columns of any one of the magnetic cores are the same.

### CROSS REFERENCE

The present application is based on and claims priority to Chinese Patent Application No. 2024100155504, filed on Jan. 4, 2024, the entire contents of which are incorporated herein by reference.

### TECHNICAL FIELD

The present disclosure relates to the field of transformer technologies, and in particular to an integrated transformer and a power module.

### BACKGROUND

Both main transformers for main power conversion and auxiliary transformers for auxiliary power conversion are required in power modules.

It should be noted that the information disclosed in the Background section above is only for enhancing the understanding of the background of the present disclosure, and thus may include information that does not constitute prior art known to those of ordinary skill in the art.

### SUMMARY

The present disclosure provides an integrated transformer and a power module.

According to a first aspect of the present disclosure, there is provided an integrated transformer, including:
two magnetic cores, including a first magnetic core and a second magnetic core, wherein each of the magnetic cores includes two magnetic yokes and two magnetic columns, the two magnetic yokes are arranged opposite to each other along a first direction, the two magnetic columns are located between the two magnetic yokes, the two magnetic columns are arranged opposite to each other along a second direction, and an angle between the second direction and the first direction is greater than 0 degree;
two short-circuited magnetic blocks, including a first short-circuited magnetic block and a second short-circuited magnetic block, wherein one magnetic yoke of the first magnetic cores is connected to one magnetic yoke of the second magnetic core through the first short-circuited magnetic blocks, and other magnetic yoke of the first magnetic core is connected to other magnetic yoke of the second magnetic core through the second short-circuited magnetic block to connect the two magnetic cores and the two short-circuited magnetic blocks in series into a ring;
four first windings, wound on four magnetic columns of the two magnetic cores, respectively; and
at least one second winding, wound on the magnetic core or the short-circuited magnetic block, wherein magnetic flux directions generated by the second winding in two magnetic columns of any one of the magnetic cores are the same.

According to a second aspect of the present disclosure, there is further provided a power module, including the integrated transformer as described in the first aspect.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows a schematic diagram of a circuit topology structure of an SST converting a medium voltage of 10 kV into a low voltage output of 270V according to an embodiment of the present disclosure;

FIG. 2 shows a schematic structural diagram of a magnetic core connection of an integrated transformer according to an embodiment of the present disclosure;

FIG. 3 shows a schematic diagram of a magnetic column in an integrated transformer according to an embodiment of the present disclosure;

FIG. 4 shows a structural diagram of another magnetic core connection of an integrated transformer according to an embodiment of the present disclosure;

FIG. 5 shows a schematic diagram of a position of an insulation structure in an integrated transformer according to an embodiment of the present disclosure;

FIG. 6 shows a cross-sectional schematic diagram of an integrated transformer with an insulation structure according to an embodiment of the present disclosure;

FIG. 7 shows a schematic structural diagram of an integrated transformer according to an embodiment of the present disclosure;

FIG. 8 shows a schematic structural diagram of an integrated transformer according to an embodiment of the present disclosure;

FIG. 9 shows a schematic structural diagram of an integrated transformer according to an embodiment of the present disclosure;

FIG. 10 shows a schematic structural diagram of an integrated transformer according to an embodiment of the present disclosure; and

FIG. 11 shows a schematic structural diagram of an integrated transformer according to an embodiment of the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The described features, structures or characteristics may be combined in any suitable manner in one or more embodiments.

In addition, the drawings are merely schematic representations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

As described above, both main transformers for main power conversion and auxiliary transformers for auxiliary power conversion are required in power modules. In the related arts, one method is to provide a separate auxiliary isolation transformer to cooperate with an auxiliary power, but the auxiliary transformer provided in this method is not integrated with the main transformer, the number of magnetic components and the volume difference are relatively large, an overall structure is relatively messy, resulting in a very low power density of the power module; and due to volume limitations, the efficiency of a separate auxiliary power tends to be low. Another method is to add an output to the main transformer as the auxiliary transformer, but this integration method requires that the two outputs must be of the same frequency and the same input source, otherwise mutual interference therebetween cannot be avoided. Therefore, such integration scheme leads to considerable limitations on the flexibility of control and system architecture.

Specific implementations of embodiments of the present disclosure will be described in detail below with reference to the accompanying drawings.

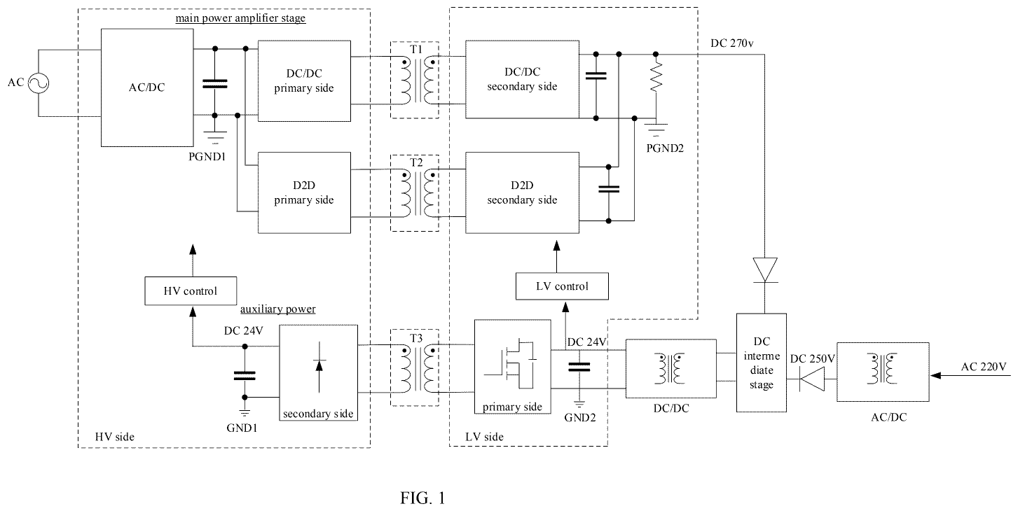

FIG. 1 shows that a medium voltage Solid-State Transformer (SST) adopts a solution in which power is directly drawn from a distribution network to convert a medium voltage of 10 kV into a low voltage output of 270V. An SST is composed of multiple power modules connected in series and parallel. As shown, a single power module includes one AC/DC unit and two DC/DC units with output terminals connected in parallel. A transformer (main transformer) of the DC/DC unit plays a role of electrical isolation between a main power medium voltage side (including AC/DC, DC/DC primary side) and a main power low voltage side (DC/DC secondary side), and needs to meet a medium voltage insulation level. In addition to the main power topology, the medium voltage side and the low voltage side each require auxiliary circuits such as control circuits, drive circuits, and detection circuits. These circuits all need to be powered by auxiliary powers, and the auxiliary powers on both the medium voltage side and the low voltage side also need to realize a medium voltage electrical isolation function. Since the auxiliary power of the medium voltage side circuit needs high voltage-resistant electronic components to draw power from a grid side voltage or an AC/DC bus capacitor, which increases the complexity and cost of the power supply scheme. As shown, the current auxiliary power supply scheme for a single power module is that: the auxiliary power on the medium voltage side is obtained by converting the auxiliary power on the low voltage side through an auxiliary power DC/DC, and the electrical isolation of the auxiliary power DC/DC is achieved by the auxiliary transformer; the auxiliary power on the low voltage side is converted from the 220V AC mains during startup, and is switched to, after the SST main power is started, the low voltage side output of 270V for supplying power. Therefore, a single power module of the SST contains two main transformers T1, T2 and one auxiliary transformer T3, and all three transformers must reach the same medium voltage isolation level.

The inventors have found that when two main transformers T1, T2 and one auxiliary transformer T3 are required to be provided in a single power module of the SST, if the auxiliary transformer T3 is provided separately, a separate auxiliary isolation transformer is used to cooperate with a circuit of the auxiliary power to realize the power from the low voltage side to the main power circuit on the medium voltage side to provide driving and control power supply. There are many magnetic components in a single power module, and the volume difference of the magnetic components is large, the overall structure is relatively messy, and the efficiency of the auxiliary transformer is low, resulting in a very low power density and large loss of the power module. If the main transformer is set to have a plurality of outputs, and one of the outputs is set as the auxiliary transformer, in this application scenario, the transformer has at least two inputs, one is the medium voltage side voltage of 10 kV, and the other is the mains 220V. There is a high coupling between the two inputs, and they interfere with each other.

In order to solve the problem that the power density of the power module is very low, the loss of the power module is very large, or there is high coupling and mutual interference between the inputs of the power module caused by the transformer setting in the above medium voltage conversion scenario, embodiments of the present disclosure provide an integrated transformer, which integrates the main transformer and the auxiliary transformer together to improve the power density of the power module and reduce the loss of the power module. In addition, inputs of the main transformer and the auxiliary transformer are independent to prevent coupling interference between the two inputs.

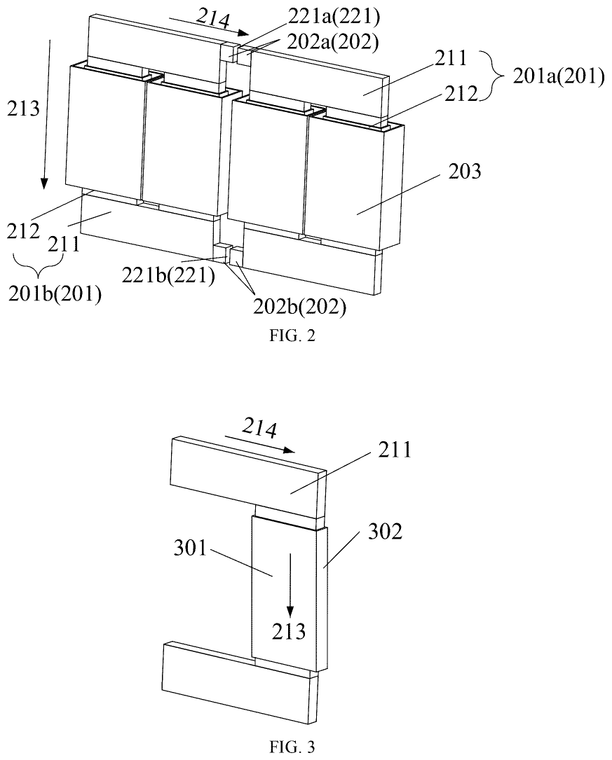

As shown in FIGS. 2 to 11, an integrated transformer provided in embodiments of the present disclosure includes:
two magnetic cores 201, including a first magnetic core 201a and a second magnetic core 201b, each magnetic core 201 includes two magnetic yokes 211 and two magnetic columns 212, the two magnetic yokes 211 are arranged opposite to each other along a first direction 213, the two magnetic columns 212 are located between the two magnetic yokes 211, and the two magnetic columns 212 are arranged opposite to each other along a second direction 214, and there is an angle between the second direction 214 and the first direction 213, which is greater than 0 degree;
two short-circuited magnetic blocks 202, including a first short-circuited magnetic block 202a and a second short-circuited magnetic block 202b, one magnetic yoke 211 in the first magnetic core 201a is connected to one magnetic yoke 211 in the second magnetic core 201b through the first short-circuited magnetic block 202a, and other magnetic yoke 211 of the first magnetic core 201a is connected to other magnetic yoke 211 of the second magnetic core 201b through the second short-circuited magnetic block202b, so that the two magnetic cores 201 and the two short-circuited magnetic blocks 202 are connected in series to form a ring; it should be noted that the short-circuited magnetic block 202 and the magnetic yoke 211 can be directly connected or indirectly connected, for example, indirectly connected through an air gap to increase leakage flux;
four first windings 203, respectively wound on four magnetic columns 212 of the two magnetic cores 201; and
at least one second winding 204, wound on the magnetic core 201 or the short-circuit magnetic block 202; it should be noted that magnetic flux directions generated by the second winding 204 in the two magnetic columns 212 of any magnetic core 201 are the same.

By winding the second winding on the magnetic core or the short-circuited magnetic block, the auxiliary transformer and the main transformer share the magnetic element, realizing the integration of the auxiliary transformer and the main transformer to reduce the volume and loss of the integrated transformer, thereby improving the power density of the integrated transformer. By providing the first winding and the second winding separately, the inputs of the auxiliary transformer and the main transformer are independent, the coupling between the inputs of the auxiliary transformer and the main transformer is extremely small, and the interference is also relatively low.

It should be noted that, in some embodiments of the present disclosure, the angle ranges from 85 degrees to 95 degrees, that is, the first direction 213 is approximately perpendicular to the second direction 214. Further, in some embodiments of the present disclosure, the angle is 90 degrees, and the first direction 213 is perpendicular to the second direction 214. When the first direction 213 is perpendicular to the second direction 214, that is, when the magnetic yoke 211 is perpendicular to the magnetic column 212 of the same magnetic core 201, a magnetic path length of the same magnetic core 201 is the shortest and a volume of the magnetic core 201 is the smallest in a case of maintaining the same magnetic core window area. The magnetic core window refers to a space jointly surrounded by the two magnetic yokes 211 and the two magnetic columns 212 of the same magnetic core 201, and the magnetic path length refers to a circumference of the magnetic core window.

It should be noted that the two first windings 203 wound on the two magnetic columns 212 of the same magnetic core 201 form one main transformer, that is, the four first windings 203 constitute two main transformers, and one second winding 204 constitutes one auxiliary transformer. In other words, the integrated transformer provided in the embodiments of the present disclosure at least integrates two main transformers and one auxiliary transformer. It can be understood by those skilled in the art that the number of auxiliary transformers integrated in the integrated transformer is not fixed, that is, the number of second windings 204 is not fixed, which may be one, two, three, etc., and may be set according to actual needs, which is not limited by the embodiments of the present disclosure.

In some embodiments of the present disclosure, each first winding 203 includes a first primary winding and a first secondary winding, first primary windings wound on the two magnetic columns 212 of the same magnetic core 201 are connected in series, and first secondary windings wound on the two magnetic columns 212 of the same magnetic core 201 are connected in series. Through the series winding method, induced voltages generated by the magnetic flux of the auxiliary transformer can have opposite directions on the first primary windings (or first secondary windings) in series wound on the two magnetic columns 212 of the same magnetic core 201, which can cancel each other. Furthermore, turn numbers of the first primary windings on the two magnetic columns 212 of the same magnetic core 201 are the same, and turn numbers of the first secondary windings on the two magnetic columns 212 of the same magnetic core 201 are the same, which can make the induced voltages generated by the magnetic flux of the auxiliary transformer completely offset on the first primary windings in series wound on the two magnetic columns 212 of the same magnetic core 201, and can make the induced voltages generated by the magnetic flux of the auxiliary transformer completely offset on the first secondary windings in series wound on the two magnetic columns 212 of the same magnetic core 201, that is, the induced voltage caused by the auxiliary transformer in each main transformer is 0. The turn numbers of the first primary windings on the two magnetic columns 212 of the same magnetic core 201 being the same and the turn numbers of the first secondary windings on the two magnetic columns 212 of the same magnetic core 201 being the same mean that heights of the first primary windings on the two magnetic columns 212 are the same, and heights of the first secondary windings on the two magnetic columns 212 are also the same, that is, a height of the magnetic core window is used in a maximized manner, thereby achieving decoupling of the main transformer and the auxiliary transformer, avoiding performance degradation or failure caused by a coupling effect between the transformers, and reducing the mutual influence between the main transformer and the auxiliary transformer.

In some embodiments of the present disclosure, each second winding 204 includes a second primary winding and a second secondary winding. Specifically, in some embodiments of the present disclosure, when the number of second windings 204 is one, the second winding 204 can be wound on any one of the magnetic cores 201, and accordingly, the second primary winding and the second secondary winding are concentrically wound on two magnetic columns 212 of any one of the magnetic cores 201. Specifically, in some embodiments of the present disclosure, when the number of second windings 204 is two, each second winding 204 is wound on two magnetic columns 212 of the same magnetic core 201. It should be noted that the two second windings 204 can be wound on two magnetic cores 201, respectively, or can be wound on the same magnetic core 201, which may be any one of the two magnetic cores 201. Specifically, in some embodiments of the present disclosure, the second winding 204 may also be wound on the magnetic yoke 211 of the magnetic core 201. When the number of second windings 204 is one, the second primary winding and the second secondary winding are concentrically wound on any magnetic yoke 211 of any magnetic core 201. When the number of second windings 204 is four, the four magnetic yokes 211 of the two magnetic cores 201 are respectively wound with one second winding 204, and the second primary winding and the second secondary winding included in each second winding 204 are concentrically wound on the same magnetic yoke 211. Specifically, in some embodiments of the present disclosure, the second winding 204 may be wound on the short-circuited magnetic block 202. When the number of second windings 204 is one, the second primary winding and the second secondary winding are concentrically wound on any short-circuited magnetic block 202. In some embodiments of the present disclosure, the number of second windings 204 is two, the two second windings 204 are respectively wound on two short-circuited magnetic blocks 202, and the second primary winding and the second secondary winding included in each second winding 204 are concentrically wound on the same short-circuited magnetic block 202.

In some embodiments of the present disclosure, when the winding position of the second winding 204 varies, there may be a situation where the magnetic flux of the auxiliary transformer is inconsistently distributed on the two magnetic columns 212 in each magnetic core 201. In this case, a ratio of excitation magnetic fluxes generated by the second winding 204 in the two magnetic columns 212 of the same magnetic core 201 is a first ratio; a ratio of the turn numbers of the first primary windings wound on the two magnetic columns 212 of the same magnetic core 201 is a second ratio; and a product of the first ratio and the second ratio is one, so as to ensure that the induced voltages generated by the magnetic flux of the auxiliary transformer can be completely offset on the first primary windings in series wound on the two magnetic columns 212 of the same magnetic core 201. Furthermore, the turn number of the first secondary winding wound on a magnetic column 212 of a magnetic core 201 does not need to be consistent with the turn number of the first primary winding wound on the same magnetic column 212 of the same magnetic core 201. It is only necessary to ensure that a ratio of the turn numbers of the first secondary windings wound on the two magnetic columns 212 in the same magnetic core 201 is the same as the second ratio, which can ensure that the induced voltages generated by the magnetic flux of the auxiliary transformer can be completely offset on the first secondary windings connected in series on the two magnetic columns 212 of the same magnetic core 201, thereby achieving decoupling of the main transformer and the auxiliary transformer and reducing the mutual influence between the main transformer and the auxiliary transformer.

In the integrated transformer provided in some embodiments of the present disclosure, as shown in FIG. 3, each magnetic column 212 is a cuboid, and the magnetic column 212 includes two surfaces connected to the magnetic yokes 211 and four side surfaces sequentially connected; the four side surfaces include two first side surfaces 301 arranged oppositely and two second side surfaces 302 arranged oppositely, the first side surfaces 301 and the second side surfaces 302 are connected, an area of the first side surface 301 is larger than that of the second side surface 302, and the first side surface 301 is parallel to the first direction 213, and the first side surface 301 is parallel to the second direction 214; the second side surface 302 is parallel to the first direction 213, and the second side surface 302 is perpendicular to the second direction 214. This will make each magnetic core 201 structure including two magnetic columns 212 presents a flat shape, which not only makes a volume of the magnetic yoke 211 in each magnetic core 201 relatively small, reduces the use of the magnetic component, and reduces the cost; but also makes the formed integrated transformer present a flat shape and occupy a small volume, which is not only conducive to the actual assembly of the power module, but also can improve the power density of the power module. Those skilled in the art will appreciate that a shape of the magnetic column 212 may also be a cylinder, a cube, or the like, which may be configured according to actual assembly and transformer requirements, and is not limited by embodiments of the present disclosure.

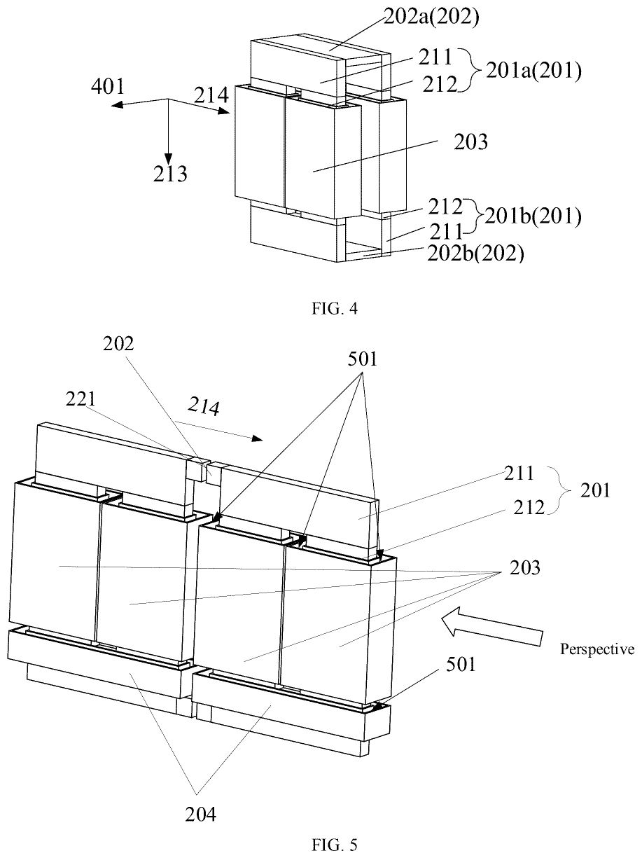

In an embodiment of the present disclosure, the two magnetic cores 201 may be connected in a flat manner or in a stacked manner. Specifically, in some embodiments of the present disclosure, an integrated transformer is provided, in which two magnetic cores 201 are connected in the flat manner. As shown in FIG. 2, the two magnetic cores 201 are arranged along the second direction 214, the two magnetic yokes 211 of the two magnetic cores 201 located on the same side along the first direction 213 are connected by the short-circuit magnetic blocks 202. In some other embodiments of the present disclosure, an integrated transformer is provided, in which two magnetic cores 201 are connected in the stacked manner. As shown in FIG. 4, the two magnetic cores 201 are arranged along a third direction 401. It should be noted that the third direction 401 is perpendicular to the first direction 213 and the second direction 214. The two magnetic yokes 211 of the two magnetic cores 201 located on the same side along the first direction 213 are connected by the short-circuit magnetic block 202.

It should be noted that, in some embodiments of the present disclosure, including two first short-circuited magnetic blocks 202a and two second short-circuit magnetic blocks 202b, one magnetic yoke in the first magnetic core 201a is connected to one magnetic yoke 211 in the second magnetic core 201b through the two first short-circuited magnetic blocks 202a, and other magnetic yoke 211 of the first magnetic core 201a is connected to other magnetic yoke 211 of the second magnetic core 201b through the two second short-circuited magnetic blocks 202b, so that the two magnetic cores 201, the two first short-circuited magnetic blocks 202a and the two second short-circuit magnetic blocks 202b are connected in series to form a ring; and as shown in FIG. 2, a first air gap 221a is arranged between the two first short-circuited magnetic blocks 202a, a second air gap 221b is arranged between the two second short-circuit magnetic blocks 202b. That is, the magnetic yokes 211 of the two magnetic cores 201 located on the same side along the first direction 213 are indirectly connected through one short-circuited magnetic block 202, one air gap 221 and one short-circuited magnetic block 202, so as to increase the leakage flux. Further, in some embodiments of the present disclosure, the two magnetic cores 201 can be indirectly connected in series to form a ring through four short-circuited magnetic blocks 202, and the magnetic yokes 211 of the two magnetic cores 201 located on the same side along the first direction 213 are connected through two short-circuited magnetic blocks 202, and an air gap 221 is arranged between the two short-circuited magnetic blocks 202.

In some embodiments of the present disclosure, each short-circuit magnetic block 202 is integrally formed with the adjacent magnetic yoke 211, which makes a structure composed of the magnetic core 201 and the short-circuit magnetic block 202 have higher stability and the integrated transformer have a longer service life, and also makes the preparation of the magnetic components of the integrated transformer simpler without the need for additional connection processes, and the preparation cost be lower.

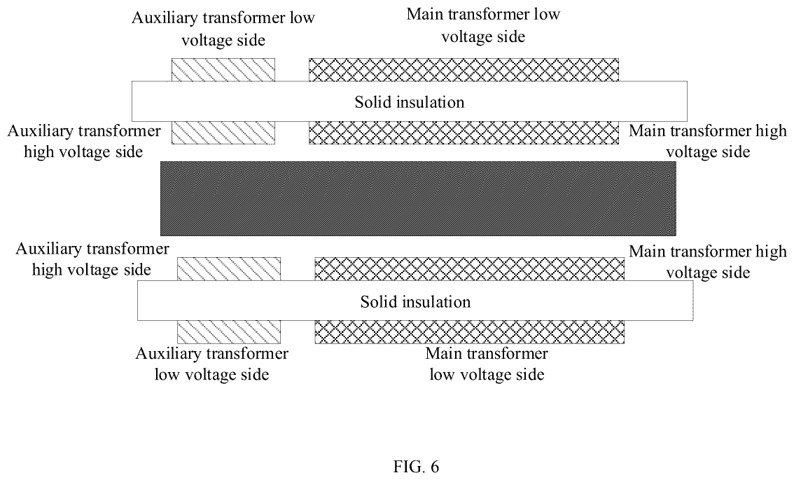

In some embodiments of the present disclosure, as shown in FIG. 5, an integrated transformer is provided, which further includes an insulation structure 501. Each first winding 203 includes a first primary winding and a first secondary winding, and the insulation structure is configured to isolate the first primary winding from the first secondary winding, and to isolate the second primary winding from the second secondary winding. FIG. 6 is a cross-sectional schematic diagram of an integrated transformer obtained from a cross-sectional perspective in an arrow direction shown in FIG. 5, and the insulation structure used in FIG. 6 is solid insulation. It can be seen that the main transformer and the auxiliary transformer share the insulation structure, and the integrated transformer adopts the insulation-sharing design, thereby simplifying the transformer structure, reducing the use of insulating materials, and reducing the manufacturing cost of the integrated transformer on the basis of meeting the insulation requirements. It can be understood by those skilled in the art that the solid insulation structure in FIG. 6 is only for illustration, which is represented by a rectangle, and may also be bent in an actual application, which will change according to the relative position between the first winding and the second winding.

Based on the same inventive concept, embodiments of the present disclosure further provide a power module as described in the following embodiments. Since a principle of solving the problem in the power module embodiments is similar to that in the above integrated transformer embodiments, the implementation of the power module embodiments may refer to the implementation of the above integrated transformer embodiments, and the repeated parts will not be repeated.

In embodiments of the present disclosure, there is further provided a power module, including any of the integrated transformers described in the above embodiments. Specifically, the power module may further include a main power and an auxiliary power for voltage conversion, as well as auxiliary circuits on both sides of the voltage conversion, a voltage conversion unit, such as a DC/DC unit, an AC/DC unit, etc. It can be understood by those skilled in the art that the power module is configured to achieve the medium and low voltage isolation function and voltage adjustment of the main power part and the auxiliary power part through the integrated transformer, and the specific structure can be set according to actual needs, which is not limited by embodiments of the present disclosure.

In order to better illustrate the integrated transformer provided by the embodiments of the present disclosure, several specific examples are given for further explanation.

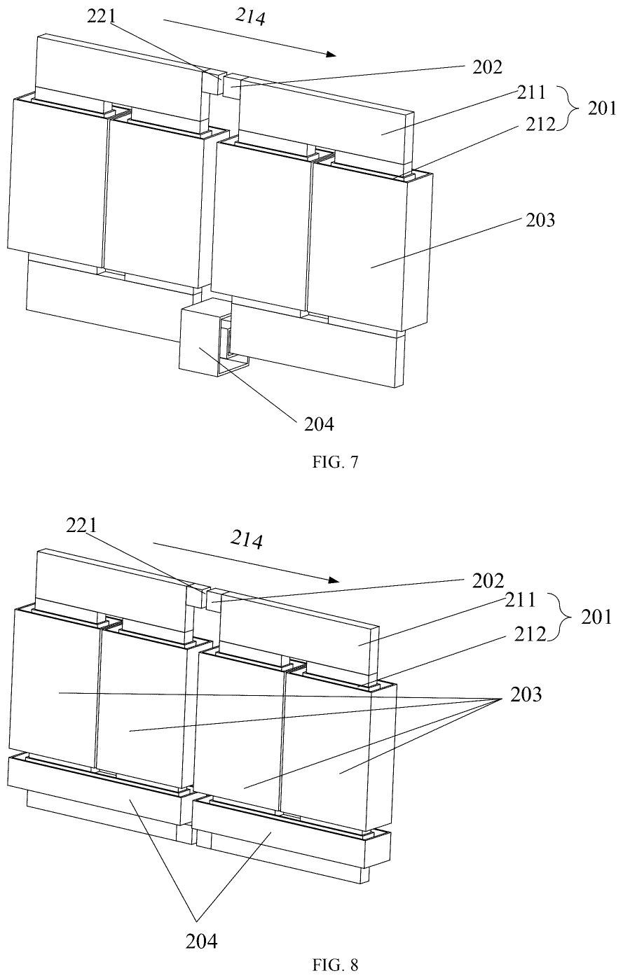

An integrated transformer provided by an embodiment of the present disclosure is shown in FIG. 7. Two magnetic cores 201 are connected in a flat manner, the two magnetic cores 201 are arranged along a second direction 214, and two magnetic yokes 211 of the two magnetic cores 201 located on the same side along a first direction 213 are connected through short-circuit magnetic blocks 202, and the two magnetic cores 201 are connected in series to form a ring through four short-circuit magnetic blocks 202, and an air gap 221 is provided between the two short-circuit magnetic blocks 202 connecting the two magnetic yokes 211. Four first windings 203 are respectively wound on four magnetic columns 212 of the two magnetic cores 201, each first winding 203 includes a first primary winding and a first secondary winding, two first primary windings wound on two magnetic columns 212 of the same magnetic core 201 are connected in series, and two first secondary windings wound on two magnetic columns 212 of the same magnetic core 201 are connected in series. Turn numbers of the first primary windings on the two magnetic columns 212 of the same magnetic core 201 are the same, and turn numbers of the first secondary windings on the two magnetic columns 212 of the same magnetic core 201 are the same, which can make the induced voltages generated by the magnetic flux of the auxiliary transformer completely offset on the first primary windings in series wound on the two magnetic columns 212 of the same magnetic core 201, and can make the induced voltages generated by the magnetic flux of the auxiliary transformer completely offset on the first secondary windings in series wound on the two magnetic columns 212 of the same magnetic core 201, that is, the induced voltage caused by the auxiliary transformer in each main transformer is 0. One second winding 204 is included, and the second winding 204 is wound on two short-circuited magnetic blocks 202. The second winding 204 includes a second primary winding and a second secondary winding which are concentrically wound on the two short-circuited magnetic blocks 202, so that magnetic flux directions generated by the second winding 204 in two magnetic columns 212 of any magnetic core 201 are the same.

It should be noted that a size of the short-circuit magnetic block 202 can be set according to actual needs, so that by adjusting the size of the short-circuit magnetic block 202, an effective cross-sectional area of the magnetic element corresponding to the short-circuit magnetic block 202 and a turn length of the second winding 204 can be more flexibly adjusted, and then when an output voltage of the auxiliary transformer is low, the loss of the auxiliary transformer can be reduced by reducing the turn length of the second winding 204.

In this embodiment, the auxiliary transformer formed by the second winding 204 is completely integrated with the main transformer formed by the first winding 203, and there is no need to additionally provide a separate magnetic core for the auxiliary transformer, the cost is low, the assembly process is relatively simple, and the power density of the power unit is improved. The main transformer and the auxiliary transformer have independent inputs, the coupling is extremely small, and there is no mutual interference. Due to the symmetry of the structure, the magnetic fluxes of the two main transformers are offset in the second winding 204 corresponding to the auxiliary transformer, and the induced voltages of the magnetic flux of the auxiliary transformer are offset on windings in series wound on the two magnetic columns 212 corresponding to each main transformer, thereby realizing the decoupling of the auxiliary transformer and the main transformer.

An integrated transformer provided by an embodiment of the present disclosure is shown in FIG. 8. Two magnetic cores 201 are connected in a flat manner, and a second winding 204 is wound on a magnetic yoke 211. Specifically, the two magnetic cores 201 are arranged along a second direction 214, and two magnetic yokes 211 of the two magnetic cores 201 located on the same side along a first direction 213 are connected through short-circuit magnetic blocks 202, and the two magnetic cores 201 are connected in series to form a ring through four short-circuit magnetic blocks 202. Four first windings 203 are respectively wound on four magnetic columns 212 of the two magnetic cores 201, each first winding 203 includes a first primary winding and a first secondary winding, two first primary windings wound on two magnetic columns 212 of the same magnetic core 201 are connected in series, and two first secondary windings wound on two magnetic columns 212 of the same magnetic core 201 are connected in series. Turn numbers of the first primary windings on the two magnetic columns 212 of the same magnetic core 201 are the same, and turn numbers of the first secondary windings on the two magnetic columns 212 of the same magnetic core 201 are the same, which can make the induced voltages generated by the magnetic flux of the auxiliary transformer completely offset on the first primary windings in series wound on the two magnetic columns 212 of the same magnetic core 201, and can make the induced voltages generated by the magnetic flux of the auxiliary transformer completely offset on the first secondary windings in series wound on the two magnetic columns 212 of the same magnetic core 201, that is, the induced voltage caused by the auxiliary transformer in each main transformer is 0. The integrated transformer shown in FIG. 8 includes two second windings 204, one second winding 204 is wound on one magnetic yoke 211 of one magnetic core 201, and the other second winding 204 is wound on one magnetic yoke 211 of the other magnetic core 201, and the two magnetic yokes 211 wound with the second windings 204 are located on the same side, so that a structure of the integrated transformer is symmetrical to make the magnetic flux distribution more uniform. Each second winding 204 includes a second primary winding and a second secondary winding which are concentrically wound on the magnetic yoke 211, so that the excitation magnetic flux directions generated by the second windings 204 in the two magnetic columns 212 of any magnetic core 201 are the same. A low voltage side of the auxiliary transformer is adjacent to a low voltage side of the main transformer, a high voltage side of the auxiliary transformer is adjacent to a high voltage side of the main transformer, and the auxiliary transformer and the main transformer share a solid insulation isolation structure.

In this embodiment, the auxiliary transformer and the main transformer share the insulation structure, which reduces the cost of achieving insulation between the primary and secondary sides of the auxiliary transformer; and multiple (e.g., two) second windings are provided to meet the output of higher power or multiple different voltage levels. The auxiliary transformer formed by the second winding 204 is completely integrated with the main transformer formed by the first winding 203, and there is no need to additionally provide a separate magnetic core for the auxiliary transformer, the cost is low, the assembly process is relatively simple, and the power density of the power unit is improved. The main transformer and the auxiliary transformer have independent inputs, the coupling is extremely small, and there is no mutual interference. Due to the symmetry of the structure, the magnetic fluxes of the two main transformers are offset in the second winding 204 corresponding to the auxiliary transformer, and the induced voltages of the magnetic flux of the auxiliary transformer are offset on windings in series wound on the two magnetic columns 212 corresponding to each main transformer, thereby realizing the decoupling of the auxiliary transformer and the main transformer.

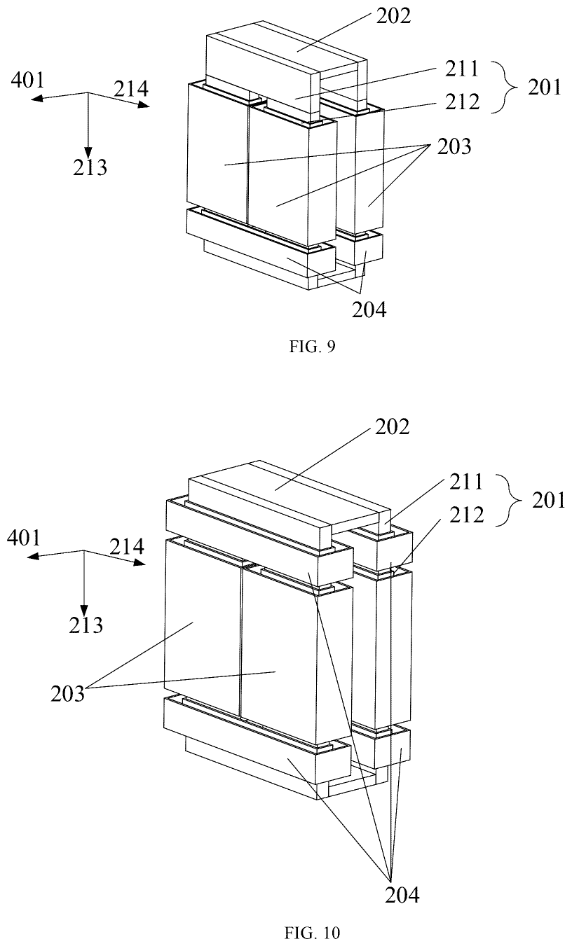

An integrated transformer provided by an embodiment of the present disclosure is shown in FIGS. 9 to 11, two magnetic cores 201 are connected in a stacked manner, and a second winding 204 is wound on a magnetic core 201 or a short-circuit magnetic block 202. Specifically, the two magnetic cores 201 are arranged along a third direction 401, and two magnetic yokes 211 of the two magnetic cores 201 located on the same side along a first direction 213 are connected through a short-circuit magnetic block 202. When the two magnetic cores 201 are connected in the stacked manner, first side surfaces 301 are arranged opposite to each other, so that the larger side surfaces of the magnetic columns are opposite to each other between the two magnetic cores 201, which can make the magnetic path of the integrated transformer more symmetrical and uniform, and also make it easier to achieve decoupling between the main transformer and the auxiliary transformer.

The integrated transformer provided in this embodiment includes four first windings 203, which are respectively wound on four magnetic columns 212 of the two magnetic cores 201, each first winding 203 includes a first primary winding and a first secondary winding, two first primary windings wound on two magnetic columns 212 of the same magnetic core 201 are connected in series, and two first secondary windings wound on two magnetic columns 212 of the same magnetic core 201 are connected in series. Turn numbers of the first primary windings on the two magnetic columns 212 of the same magnetic core 201 are the same, and turn numbers of the first secondary windings on the two magnetic columns 212 of the same magnetic core 201 are the same, which can make the induced voltages generated by the magnetic flux of the auxiliary transformer completely offset on the first primary windings in series wound on the two magnetic columns 212 of the same magnetic core 201, and can make the induced voltages generated by the magnetic flux of the auxiliary transformer completely offset on the first secondary windings in series wound on the two magnetic columns 212 of the same magnetic core 201, that is, the induced voltage caused by the auxiliary transformer in each main transformer is 0.

The integrated transformer shown in FIG. 9 includes two second windings 204, one second winding 204 is wound on one magnetic yoke 211 of one magnetic core 201, and the other second winding 204 is wound on one magnetic yoke 211 of the other magnetic core 201, and the two magnetic yokes 211 wound with the second windings 204 are located on the same side, so that a structure of the integrated transformer is symmetrical to make the magnetic flux distribution more uniform. Each second winding 204 includes a second primary winding and a second secondary winding which are concentrically wound on the same magnetic yoke 211, so that the excitation magnetic flux directions generated by the second windings 204 in the two magnetic columns 212 of any magnetic core 201 are the same.

The integrated transformer shown in FIG. 10 includes four second windings 204, and the four second windings 204 are respectively wound on four magnetic yokes 211 included in the integrated transformer, so that the structure of the integrated transformer is centrally symmetrical, and the excitation flux generated by the auxiliary transformer in each magnetic column 212 can be equal in magnitude, which is more conducive to the decoupling between the two main transformers and between the main transformer and the auxiliary transformer. Each second winding 204 includes a second primary winding and a second secondary winding which are concentrically wound on the same magnetic yoke 211, so that the excitation magnetic flux directions generated by the second windings 204 in the two magnetic columns 212 of any magnetic core 201 are the same.

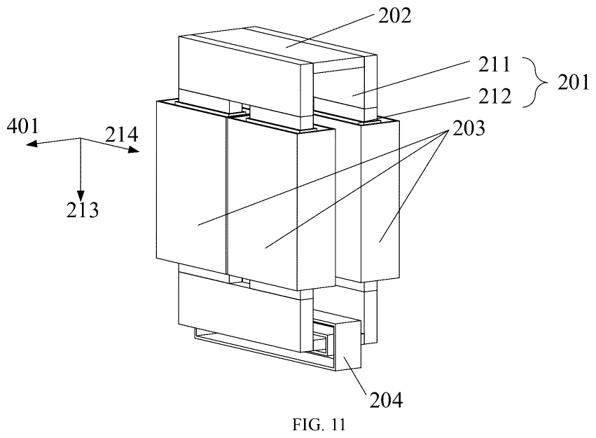

The integrated transformer shown in FIG. 11 includes one second winding 204, which is wound on one of the short-circuited magnetic blocks 202. The second winding 204 includes a second primary winding and a second secondary winding which are concentrically wound on this short-circuited magnetic block 202, so that the magnetic flux directions generated by the second winding 204 in two magnetic columns 212 of any magnetic core 201 are the same. It should be noted that a size of the short-circuit magnetic block 202 can be set according to actual needs, so that by adjusting the size of the short-circuit magnetic block 202, an effective cross-sectional area of the magnetic element corresponding to the short-circuit magnetic block 202 and a turn length of the second winding 204 can be more flexibly adjusted, and then when an output voltage of the auxiliary transformer is low, the loss of the auxiliary transformer can be reduced by reducing the turn length of the second winding 204.

In this embodiment, the auxiliary transformer formed by the second winding 204 is completely integrated with the main transformer formed by the first winding 203, and there is no need to additionally provide a separate magnetic core for the auxiliary transformer, the cost is low, the assembly process is relatively simple, and the power density of the power unit is improved. The main transformer and the auxiliary transformer have independent inputs, the coupling is extremely small, and there is no mutual interference. Due to the symmetry of the structure, the magnetic fluxes of the two main transformers are offset in the second winding 204 corresponding to the auxiliary transformer, and the induced voltages of the magnetic flux of the auxiliary transformer are offset on windings in series wound on the two magnetic columns 212 corresponding to each main transformer, thereby realizing the decoupling of the auxiliary transformer and the main transformer. In addition, multiple second windings 204 can be provided to meet the output of higher power or multiple different voltage levels.

In the integrated transformer provided the embodiment of the present disclosure, turn numbers of first primary windings on two magnetic columns 212 of the same magnetic core 201 are different, turn numbers of first secondary windings on two magnetic columns 212 of the same magnetic core 201 are different, a ratio of the turn numbers of the first primary windings wound on the two magnetic columns 212 of the same magnetic core 201 is set to a second ratio, and a ratio of the turn numbers of the first secondary windings wound on the two magnetic columns 212 of the same magnetic core 201 is also set to the second ratio. The second ratio is the reciprocal of a first ratio, and the first ratio is a ratio of the excitation fluxes generated by the second winding 204 in the two magnetic columns 212 of the same magnetic core 201. By adjusting the turn number of the first winding 203, the decoupling of the main transformer and the auxiliary transformer is achieved when the excitation flux distribution generated by the second winding 204 under different structures of the integrated transformer is inconsistent.

Assuming that the excitation fluxes generated by the second winding 204 in a first magnetic column and a second magnetic column of the same magnetic core 201 are Φₐ and Φ_{b}, a ratio of the turn numbers of the first primary windings wound on the first magnetic column and the second magnetic column in the magnetic core 201 is Na/Nb=Φ_{b}/Φₐ.

In the integrated transformer provided in the embodiments of the present disclosure, the two magnetic cores are provided, each magnetic core includes the two magnetic yokes and the two magnetic columns, the two magnetic yokes are arranged opposite to each other along the first direction, the two magnetic columns are located between the two magnetic yokes, and the two magnetic columns are arranged opposite to each other along the second direction. There is an angle between the second direction and the first direction, and the angle is greater than 0 degrees. The two short-circuited magnetic blocks are provided, one magnetic yoke in one magnetic core is connected to one magnetic yoke in the other magnetic core through one short-circuited magnetic block, so that the two magnetic cores are connected in series into the ring. The four first windings are provided, which are respectively wound on the four magnetic columns of the two magnetic cores, as the main transformers. The at least one second winding is provided, which is wound on the magnetic core or the short-circuited magnetic block, and the second winding is arranged so as to generate the same magnetic flux direction in the two magnetic columns of any magnetic core, as an auxiliary transformer. By sharing the magnetic core or providing the auxiliary transformer to use the short-circuited magnetic block used for the connection of the magnetic core, the main transformer and the auxiliary transformer are integrated, and the efficiency and power density of the auxiliary transformer are improved; and the main transformer and the auxiliary transformer use independent windings and independent inputs, and the coupling between the main transformer and the auxiliary transformer is extremely small and will not interfere with each other.

Those skilled in the art can understand that various aspects of the present disclosure may be implemented as a system, a method, or a program product. Therefore, various aspects of the present disclosure can be embodied in the following forms: a complete hardware implementation, a complete software implementation (including firmware, microcode, etc.), or a combination of hardware and software implementations, which can be collectively referred to as “circuit”, “module’, or “system”. It should be noted that although several modules or units of devices for executing actions in the above detailed description are mentioned, such division of modules or units is not mandatory. In fact, features and functions of two or more of the modules or units described above may be embodied in one module or unit in accordance with embodiments of the present disclosure. Alternatively, the features and functions of one module or unit described above may be further divided into multiple modules or units.

In addition, although various steps of the method of the present disclosure are described in a particular order in the figures, this is not required or implied that the steps must be performed in the specific order, or all the steps shown must be performed to achieve the desired result. Additionally or alternatively, certain steps may be omitted, multiple steps may be combined into one step, and/or one step may be decomposed into multiple steps and so on.

Through the description of the above embodiments, those skilled in the art will readily understand that the example embodiments described herein may be implemented by software or by a combination of software with necessary hardware. Therefore, the technical solutions according to embodiments of the present disclosure may be embodied in the form of a software product, which may be stored in a non-volatile storage medium (which may be a CD-ROM, a USB flash drive, a mobile hard disk, etc.) or on a network. A number of instructions are included to cause a computing device (which may be a personal computer, server, mobile terminal, or network device, etc.) to perform the methods in accordance with embodiments of the present disclosure.

Other embodiments of the present disclosure will be apparent to those skilled in the art after those skilled in the art consider the specification and practice the technical solutions disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

What is claimed is:

1. An integrated transformer, comprising:
two magnetic cores, comprising a first magnetic core and a second magnetic core, wherein each of the magnetic cores comprises two magnetic yokes and two magnetic columns, the two magnetic yokes are arranged opposite to each other along a first direction, the two magnetic columns are located between the two magnetic yokes, the two magnetic columns are arranged opposite to each other along a second direction, and an angle between the second direction and the first direction is greater than 0 degree;
two short-circuited magnetic blocks, comprising a first short-circuited magnetic block and a second short-circuited magnetic block, wherein one magnetic yoke of the first magnetic core is connected to one magnetic yoke of the second magnetic core through the first short-circuited magnetic block, and other magnetic yoke of the first magnetic core is connected to other magnetic yoke of the second magnetic core through the second short-circuited magnetic block to connect the two magnetic cores and the two short-circuited magnetic blocks in series into a ring;
four first windings, wound on four magnetic columns of the two magnetic cores, respectively; and
a second winding, wound on the magnetic core or the short-circuited magnetic block, wherein magnetic flux directions generated by the second winding in two magnetic columns of any one of the magnetic cores are the same.

2. The integrated transformer according to claim 1, wherein each of the first windings comprises a first primary winding and a first secondary winding;
first primary windings wound on two magnetic columns of the same magnetic core are connected in series; and
first secondary windings wound on the two magnetic columns of the same magnetic core are connected in series.

3. The integrated transformer according to claim 2, wherein turn numbers of the first primary windings on the two magnetic columns of the same magnetic core are the same, and turn numbers of the first secondary windings on the two magnetic columns of the same magnetic core are the same.

4. The integrated transformer according to claim 2, wherein:
a ratio of excitation fluxes generated by the second winding in the two magnetic columns of the same magnetic core is a first ratio;
a ratio of turn numbers of the first primary windings wound on the two magnetic columns of the same magnetic core is a second ratio;
a product of the first ratio and the second ratio is one; and
a ratio of turn numbers of the first secondary windings wound on the two magnetic columns of the same magnetic core is the same as the second ratio.

5. The integrated transformer according to claim 1, wherein each of the magnetic columns is a cuboid, and comprises two surfaces connected to the magnetic yokes and four side surfaces connected in sequence;
the four side surfaces comprise two first side surfaces opposite to each other and two second side surfaces opposite to each other, the first side surfaces are connected to the second side surfaces, and an area of the first side surfaces is larger than an area of the second side surfaces;
the first side surfaces are parallel to the first direction and the second direction; and
the second side surfaces are parallel to the first direction, and are perpendicular to the second direction.

6. The integrated transformer according to claim 1, wherein the two magnetic cores are arranged along the second direction; and
the two magnetic yokes of the two magnetic cores located on the same side along the first direction are connected by the short-circuit magnetic block.

7. The integrated transformer according to claim 1, wherein the two magnetic cores are arranged along a third direction;
the third direction is perpendicular to the first direction and the second direction; and
the two magnetic yokes of the two magnetic cores located on the same side along the first direction are connected by the short-circuit magnetic block.

8. The integrated transformer according to claim 1, wherein the second winding comprises a second primary winding and a second secondary winding.

9. The integrated transformer according to claim 8, wherein the second primary winding and the second secondary winding are concentrically wound on two magnetic columns of any one of the magnetic cores.

10. The integrated transformer according to claim 9, wherein the number of second windings is two; and
each of the second windings is wound on two magnetic columns of the same magnetic core.

11. The integrated transformer according to claim 8, wherein the second primary winding and the second secondary winding are concentrically wound on any one magnetic yoke of any one of the magnetic cores.

12. The integrated transformer according to claim 11, wherein the number of second windings is four; and
four magnetic yokes in the two magnetic cores are respectively wound with one second winding.

13. The integrated transformer according to claim 8, wherein the second primary winding and the second secondary winding are concentrically wound on any one of the short-circuit magnetic blocks.

14. The integrated transformer according to claim 13, wherein the number of second windings is two; and
the two second windings are respectively wound on the two short-circuit magnetic blocks.

15. The integrated transformer according to claim 8, further comprising: an insulation structure;
each of the first windings comprises a first primary winding and a first secondary winding; and
the insulation structure is configured to isolate the first primary winding from the first secondary winding, and to isolate the second primary winding from the second secondary winding.

16. The integrated transformer according to claim 1, comprising two first short-circuit magnetic blocks and two second short-circuit magnetic blocks, wherein one magnetic yoke of the first magnetic core is connected to one magnetic yoke of the second magnetic core through the two first short-circuited magnetic blocks, and other magnetic yoke of the first magnetic core is connected to other magnetic yoke of the second magnetic core through the two second short-circuited magnetic blocks to connect the two magnetic cores, the two first short-circuited magnetic blocks and the two second short-circuited magnetic blocks in series into a ring, and a first air gap is arranged between the two first short-circuit magnetic blocks, a second air gap is arranged between the two second short-circuit magnetic blocks.

17. The integrated transformer according to claim 16, wherein each of the short-circuit magnetic blocks is integrally formed with an adjacent magnetic yoke.

18. The integrated transformer according to claim 1, wherein the angle ranges from 85 degrees to 95 degrees.

19. The integrated transformer according to claim 18, wherein the angle is 90 degrees.

20. A power module, comprising at least one integrated transformer, wherein the integrated transformer comprises:
two magnetic cores, comprising a first magnetic core and a second magnetic core, wherein each of the magnetic cores comprises two magnetic yokes and two magnetic columns, the two magnetic yokes are arranged opposite to each other along a first direction, the two magnetic columns are located between the two magnetic yokes, the two magnetic columns are arranged opposite to each other along a second direction, and an angle between the second direction and the first direction is greater than 0 degree;
two short-circuited magnetic blocks, comprising a first short-circuited magnetic block and a second short-circuited magnetic block, wherein one magnetic yoke of the first magnetic core is connected to one magnetic yoke of the second magnetic core through the first short-circuited magnetic block, and other magnetic yoke of the first magnetic core is connected to other magnetic yoke of the second magnetic core through the second short-circuited magnetic block to connect the two magnetic cores and the two short-circuited magnetic blocks in series into a ring;
four first windings, wound on four magnetic columns of the two magnetic cores, respectively; and
a second winding, wound on the magnetic core or the short-circuited magnetic block, wherein magnetic flux directions generated by the second winding in two magnetic columns of any one of the magnetic cores are the same.
